(19) United States
(12) Patent Application Publication
(10) Pub. No.: US 2025/0109360 A1
(43) Pub. Date: Apr. 3, 2025

(54) COMPOSITION COMPRISING MODIFIED CARBOXYMETHYL CELLULOSE AS DISPERSION PERFORMANCE ENHANCERS

(71) Applicant: ISP INVESTMENTS LLC, Bridgewater, NJ (US)

(72) Inventors: Gijsbert B. KROON, Giessenburg (NL); Sounak SARKAR, Hillsborough, NJ (US); David Hutchings HOWE, Wilmington, DE (US); Joseph R. CENDAGORTA, Bronx, NY (US)

(73) Assignee: ISP INVESTMENTS LLC, Wilmington, DE (US)

(21) Appl. No.: 18/834,225

(22) PCT Filed: Jan. 31, 2023
(86) PCT No.: PCT/US2023/011922

§ 371 Date: Jul. 29, 2024

Related U.S. Application Data
(60) Provisional application No. 63/304,837, filed on Jan. 31, 2022.

(51) Int. Cl. C11D 3/22; C08B 11/12; C08B 11/20; C11D 3/00

(52) U.S. Cl. CPC C11D 3/225; C08B 11/12; C08B 11/20; C11D 3/0036

(57) ABSTRACT

Disclosed is a water-soluble biodegradable dispersant composition having a low to medium molecular weight carboxylated polysaccharide functionalized with at least one mono-valent (M⁺) cation and at least one di-valent (M⁺⁺) cation and an optional adjunct material. More particularly, a laundry or detergent composition provides soil resistant textiles by means of treatment with an anti-soil redeposition agent carboxymethyl cellulose (CMC) comprising sodium-calcium carboxymethyl cellulose, sodium-magnesium carboxymethyl cellulose, sodium-zinc carboxymethyl cellulose. sodium-calcium-zinc carboxymethyl cellulose, sodium-calcium-magnesium-carboxymethyl cellulose or sodium-magnesium-zinc-carboxymethyl cellulose.

### FIELD OF THE INVENTION

The present application relates to a water-soluble dispersant composition and more particularly, to a laundry or detergent composition which contains a low to medium molecular weight carboxylated polysaccharide functionalized with at least one mono-valent (M⁺) cation and at least one di-valent (M⁺⁺) cation.

### BACKGROUND OF THE INVENTION

The finishing of textile materials to prepare wash-and-wear fabrics and durable-press fabrics has received a lot of attention in the textile industry in recent years. Textiles, fabrics and garments such as dress slacks, suits, curtains, tablecloths, and industrial fabrics have a higher tendency to retain stains and absorb soil from unclean wash water during laundering, which causes fabric graying issues. This problem of soil release from dirty and soiled laundry and soil pickup by laundered fabrics from dirty wash liquid during washing will hereinafter be referred to as soil redeposition.

Any liquid or powdered laundry detergent should not only remove soil from clothing, but also prevent soil that has been removed and suspended in the washing solution from redepositing onto the fabric's surface as the wash water is removed.

Carboxylated polysaccharides such as carboxymethyl cellulose, carboxymethyl inulin, carboxymethyl guar or carboxymethyl starch and Cellulose ethers have long been explored as an anti-soil redeposition ingredient in laundry detergents. Carboxymethylcellulose (CMC) is found in a significant number of commercially available detergent compositions for both domestic and industrial use, and its anti-soil redeposition efficacy is well established. However, it is well recognized that such efficacy is often only obtained with cotton fabrics, and that CMC has little or no anti-soil redeposition effect when the washing material is a synthetic fabric and inadequate in preventing redeposition of soil onto such fabrics during the washing cycle.

U.S. Pat. No. 3,959,165A discloses heavy duty synthetic organic detergent composition comprising anti-soil redeposition agents selected from the group consisting of sodium carboxymethyl cellulose, polyvinyl alcohol, polyvinyl pyrrolidone, hydroxypropyl methyl cellulose and hydroxyethyl cellulose.

U.S. Pat. No. 3,629,121A describes a detergent composition with reduced soil-redeposition effect comprising ternary mixture of Na carboxymethyl cellulose (Na-CMC) a linear polycarboxylate and a 1-3C alkyl cellulose which is free of other substituents and has a substitution degree (DS) of at least 0.5 and a polymerization degree (PD) of not more than 300.

PCT Application 202006554A1 discloses a charged polymer complex microemulsion comprising: (a) a substantially water-immiscible oil phase; (b) an aqueous phase; (c) a surfactant selected from the group of carboxymethylcellulose calcium, hydroxypropyl celluloses, hydroxypropyl methylcellulose, carboxymethylcellulose sodium, methylcellulose; and (d) a charged polymer complex used for prevention of soil-redeposition.

JP Patent 2311600A discloses a tablet detergent composition with good water solubility containing granular anionic surfactant(s) and free (or acid-form) carboxymethyl cellulose, calcium carboxymethyl cellulose, magnesium carboxymethyl cellulose, and aluminum carboxymethyl cellulose powder as decaying agent.

U.S. Pat. No. 7,781,387 B2 discloses a dry automatic dishwashing detergent comprises spot reduction system that includes (i) a sodium polyacrylate having a molecular weight between about 1,000 and 10,000 and (ii) about 0.1% to about 2% of the composition of a sodium carboxymethyl inulin having a degree of substitution of about 2.5, wherein the ratio of polyacrylate to sodium carboxymethyl inulin is from about 2.5:1 to about 3:1

US Publication 20110143986 A1 discloses a detergent composition includes an organic builder selected from MGDA, GLDA, IDS carboxymethyl inulin, their salts, and mixtures thereof.

There is a need to provide a dispersant and laundry or detergent composition that is effective in minimizing or preventing soil redeposition from wash water onto laundered fabrics. Preventing soil redeposition during laundry furnishes combined benefit of reducing progressive graying of fabrics leading to apparent aged look of the fabrics and help maintain brightness, brilliance, and overall newness of fabrics. It is desirable to have an effective anti-soil redeposition agent that can prevent deposition of different types of soils including but not limited to particulate soil, sebum, grease, oil or mixture of them, and works effectively on different fabric types including natural (cotton) synthetic or blends thereof.

The present invention applies to a water-soluble dispersant composition and more particularly to laundry or detergent compositions which contain a low to medium molecular weight carboxymethyl cellulose functionalized with at least one mono-valent cation and at least one di-valent cation which can hinder and reduce the effect of soil-redeposition on washed fabric during laundry and effectively prevent fabric graying through repeated laundry of the fabrics. Commonly accepted mode of action of an anti-soil redeposition agent is to act as a dispersant keeping soil dispersed in the wash liquid thereby preventing soil redeposition on fabrics during laundry.

### SUMMARY OF THE INVENTION

The primary aspect of the present application is to provide a water-soluble dispersant composition and more particularly to laundry or detergent compositions which contain a low to medium molecular weight carboxylated polysaccharide functionalized with at least one mono-valent (M⁺) cation and at least one di-valent (M⁺⁺) cation.

Another aspect of the present application is to provide a water-soluble dispersant composition and more particularly, discloses about a laundry or detergent compositions which contain a low to medium molecular weight carboxylated polysaccharide including carboxymethyl cellulose (CMC), carboxymethyl inulin, carboxymethyl guar or carboxy methyl starch functionalized with at least one mono-valent (M⁺) cation and at least one di-valent (M⁺⁺).

Another primary aspect of the present application is to provide a water-soluble dispersant composition and more particularly discloses about a laundry or detergent compositions which contain a low to medium molecular weight carboxymethyl cellulose (CMC) functionalized with at least one mono-valent (M⁺) cation and at least one di-valent (M⁺⁺) cation.

In another aspect, the present application provides a functionalized carboxymethyl cellulose (CMC) having a structure of:

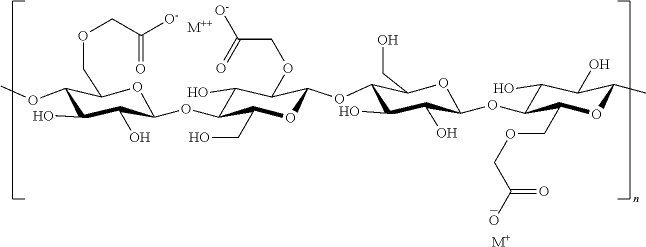

wherein M⁺ is a mono-valent cation selected from the group consisting of sodium, potassium, and lithium; and M⁺⁺ is a di-valent cation selected from the group consisting of calcium, magnesium, zinc, tin, copper, and combinations thereof; and wherein n=2 to 500, M⁺=0.1 to 10 wt. % and M⁺⁺=0.1 to 10 wt. % of the carboxymethyl cellulose.

In another aspect, the present application provides a water-soluble laundry or detergent composition and more particularly to detergent compositions which contain soil removal and an anti-soil redeposition agent having a low to medium molecular weight carboxymethyl cellulose (CMC) functionalized with at least one mono-valent (M⁺) cation and at least one di-valent (M⁺⁺) cation. Another object of the invention is to prevent soil redeposition to textiles by means of keeping stray soil dispersed in wash liquid during laundry with an anti-soil redeposition agent of the present invention.

In another aspect, the present application provides a functionalized carboxymethyl cellulose obtained by ion-exchange process comprising a reaction of (i) at least one monovalent (M⁺) carboxymethyl cellulose salt(s); and (ii) one or more divalent (M⁺⁺) metal salt(s); wherein the divalent (M⁺⁺) salt is selected from the group consisting of M⁺⁺ chloride or M⁺⁺ sulfate or M⁺⁺ carbonate, wherein the weight ratio of M⁺ to M⁺⁺ is from about 1:70 to about 70:1.

In yet another aspect, the present application provides a water-soluble laundry or detergent composition comprising: (i) about 0.1 wt. % to about 90.0 wt. % composition comprising a low to medium molecular weight carboxymethyl cellulose functionalized with at least one mono-valent cation and at least one di-valent cation(s); and (ii) optionally, about 0.0 wt. % to about 50 wt. %, of at least one or more adjunct materials; wherein the functionalized carboxymethyl cellulose is functioning as (a) dispersant; (b) a soil removal agent and (c) an anti-soil redeposition agent.

Another aspect of the present application discloses a method of providing soil removal and an anti-soil redeposition of fabrics or textile articles comprising the steps of: (i) washing or contacting one or more fabrics or textile articles with wash solution containing a laundry or detergent composition at one or more points during the main wash of laundering process; (ii) rinsing said fabrics or textile articles with water; and (iii) allowing said fabrics or textile articles to air dry naturally or mechanically tumble-drying them, wherein said fabric or textile article are selected from the group consisting of natural fabric, synthetic fabric, natural non-woven fabric and/or synthetic non-woven fabric, cotton, denim, polyacrylics, polyamides, polyesters, polyolefins, rayons, wool, linen, jute, ramie, hemp, sisal, regenerated cellulosic fibers, leather, and combinations thereof.

### BRIEF DESCRIPTION OF THE FIGURES

Further embodiments of the present application can be understood with the appended figures.

FIG. 1(a) represents Anti-soil redeposition performance after first 3 washes with detergent (more negative dL* values indicate poorer anti-soil redeposition performance) and FIG. 1(b) represents anti-soil redeposition performance after last 3 washes without detergent (more negative dL* values indicate poorer anti-soil redeposition performance).

FIGS. 2(a) and 2(b) represents ion exchange process of Na-CMC with divalent cations.

### DETAILED DESCRIPTION OF THE INVENTION

Before explaining at least one aspect of the disclosed and/or claimed inventive concept(s) in detail, it is to be understood that the disclosed and/or claimed inventive concept(s) is not limited in its application to the details of construction and the arrangement of the components or steps or methodologies set forth in the following description or illustrated in the drawings. The disclosed and/or claimed inventive concept(s) is capable of other aspects or of being practiced or carried out in various ways. Also, it is to be understood that the phraseology and terminology employed herein is for the purpose of description and should not be regarded as limiting.

As utilized in accordance with the disclosure, the following terms, unless otherwise indicated, shall be understood to have the following meanings.

Unless otherwise defined herein, technical terms used in connection with the disclosed and/or claimed inventive concept(s) shall have the meanings that are commonly understood by those of ordinary skill in the art. Further, unless otherwise required by context, singular terms shall include pluralities and plural terms shall include the singular.

The singular forms “a,” “an,” and “the” include plural forms unless the context clearly dictates otherwise specified or clearly implied to the contrary by the context in which the reference is made. The term “Comprising” and “Comprises of” includes the more restrictive claims such as “Consisting essentially of” and “Consisting of”.

For purposes of the following detailed description, other than in any operating examples, or where otherwise indicated, numbers that express, for example, quantities of ingredients used in the specification and claims are to be understood as being modified in all instances by the term “about”. The numerical parameters set forth in the specification and attached claims are approximations that may vary depending upon the desired properties to be obtained in carrying out the invention.

All percentages, parts, proportions and ratios as used herein, are by weight of the total composition, unless otherwise specified. All such weights as they pertain to listed ingredients are based on the active level and, therefore; do not include solvents or by-products that may be included in commercially available materials, unless otherwise specified.

All publications, articles, papers, patents, patent publications, and other references cited herein are hereby incorporated herein in their entirety for all purposes to the extent consistent with the disclosure herein.

The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term soil-release” in accordance with the present invention refers to the ability of the fabric to be washed or otherwise treated to remove soil and/or oily materials that have come into contact with the fabric.

The term “monovalent cation” refers to a cation having a valency of one. Accordingly, the term “divalent cation” refers to a cation having a valency of two. The monovalent cation is selected from the group consisting of sodium, potassium, and lithium. Most preferably the monovalent cation is sodium. The divalent cation is selected from the group consisting of calcium, magnesium, zinc, tin, copper, and combinations thereof. More preferably, the divalent cation is calcium, magnesium, zinc.

In one embodiment, it is contemplated that the dispersant composition according to this invention can also employ suitable functionalized polysaccharides including but not limited to carboxyl-containing celluloses, notably carboxylated polysaccharides including carboxylated cellulose (CMC), carboxylated inulin, carboxylated starch, and carboxylated guar. Other functionalized compounds including but not limited to guar gums, chitins, chitosans, glycans, galactans, glucans, xanthan gums, alginic acids, polymannuric acids, polyglycosuronic acids, polyglucuronic acids, mannans, dextrins, cyclodextrins, as well as other synthetically carboxylated or naturally occurring carboxylated polysaccharides, which can be linear or branched.

In one embodiment, it is contemplated that the dispersant composition according to this invention can also employ suitable functionalized carboxylated polysaccharides including carboxymethyl cellulose (CMC), carboxymethyl inulin, carboxymethyl guar and carboxy methyl starch.

The term “functionalized” with reference to carboxymethyl cellulose of this application refers to the presence of monovalent and one or more divalent cations on the carboxymethylcellulose. Various monovalent and divalent cations may be introduced in a carboxymethylcellulose by way of one or more functionalization reactions known to a person having ordinary skill in the art. Non-limiting examples of functionalization reactions include ion-exchange process comprising a reaction of (i) at least one monovalent (M⁺) carboxymethyl cellulose salt(s); and (ii) one or more divalent (M⁺⁺) metal salt (s); wherein the divalent (M⁺⁺) salt is selected from the consisting group of M⁺⁺ chloride or M⁺⁺ sulfate or M⁺⁺ carbonate wherein the weight ratio of M⁺ to M⁺⁺ is from about 1:70 to about 70:1.

In one non-limiting embodiment, the term “functionalized carboxymethyl cellulose” refers to low to medium molecular weight carboxymethyl cellulose (CMC) functionalized with at least one mono-valent (M⁺) cation and at least one di-valent (M⁺⁺) cation, wherein, the mono-valent cation is selected from the group consisting of sodium, potassium, and lithium and divalent cation is selected from the group consisting of calcium, magnesium, zinc, tin copper and combinations thereof.

The term functionalized carboxymethyl cellulose refers to a structure of:

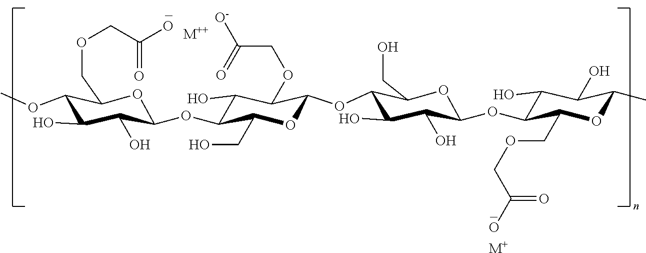

wherein M⁺ is a mono-valent cation selected from the group consisting of sodium, potassium, and lithium; and M⁺⁺ is a di-valent cation selected from the group consisting of calcium, magnesium, zinc, tin, copper, and combinations thereof; and wherein n=2 to 500, M⁺=0.1 to 10 wt. % and M⁺⁺=0.1 to 10 wt. % of the carboxymethyl cellulose.

The term functionalized carboxymethyl cellulose refers to a compound consisting of potassium-calcium carboxymethyl cellulose, potassium-magnesium carboxymethyl cellulose, potassium-zinc carboxymethyl cellulose, potassium-tin carboxymethyl cellulose, potassium-calcium-zinc-carboxymethyl cellulose, potassium-calcium-magnesium-carboxymethyl cellulose or potassium-calcium-tin-carboxymethyl cellulose, potassium-magnesium-zinc-carboxymethyl cellulose, potassium-magnesium-tin-carboxymethyl cellulose, potassium-zinc-tin-carboxymethyl cellulose.

The term functionalized carboxymethyl cellulose refers to a compound including but not limited to lithium-calcium carboxymethyl cellulose, lithium-magnesium carboxymethyl cellulose, lithium-zinc carboxymethyl cellulose, lithium-tin carboxymethyl cellulose, lithium-calcium-zinc-carboxymethyl cellulose, lithium-calcium-magnesium-carboxymethyl cellulose or lithium-calcium-tin-carboxymethyl cellulose, lithium-magnesium-zinc-carboxymethyl cellulose, lithium-magnesium-tin-carboxymethyl cellulose and lithium-zinc-tin-carboxymethyl cellulose.

The term functionalized carboxymethyl cellulose refers to a compound including but not limited to sodium-calcium carboxymethyl cellulose, sodium-magnesium carboxymethyl cellulose, sodium-zinc carboxymethyl cellulose, sodium-tin carboxymethyl cellulose, sodium-calcium-zinc-carboxymethyl cellulose, sodium-calcium-magnesium-carboxymethyl cellulose, sodium-calcium-tin-carboxymethyl cellulose, sodium-magnesium-zinc-carboxymethyl cellulose, sodium-magnesium-tin-carboxymethyl cellulose, and lithium-zinc-tin-carboxymethyl cellulose.

In one embodiment, the present application discloses an optional adjunct material selected from the group consisting of surfactants, emulsifiers, detergents, adjuvants, builders, stabilizers, rheology modifiers, solvents, radical scavengers, chelates, antifoaming agents, antistatic agent, antimicrobials, preservatives, dyes or colorants, dust mite repellents, viscosity control agents, opacifying agents, chlorine scavenger, brighteners, perfumes, finishing agents, UV absorbing or blocking agent, antibacterial agents, and solubilizing agents.

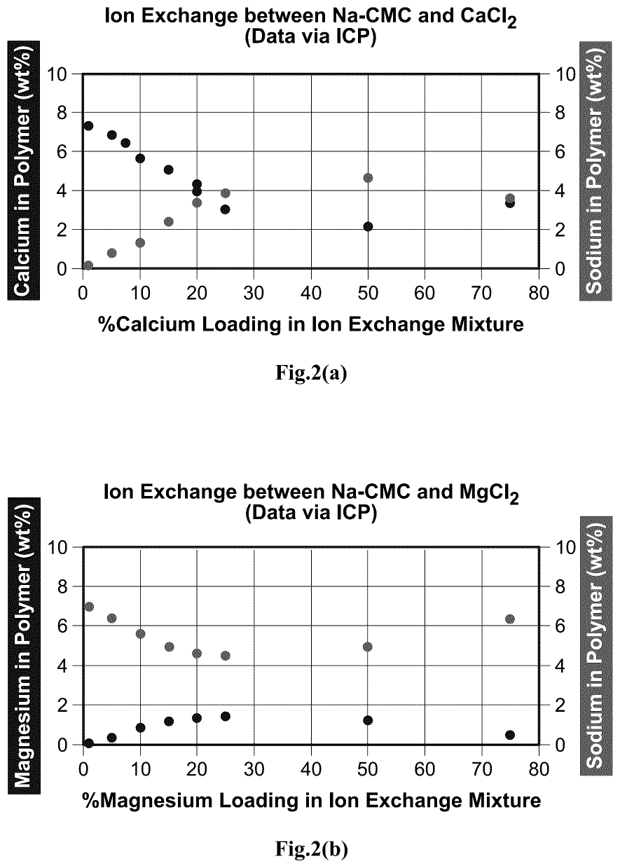

In one embodiment, the present application discloses a process for preparing functionalized carboxymethyl cellulose obtained by ion-exchange process comprising a reaction of (i) at least one monovalent (M+) carboxymethyl cellulose salt(s); and (ii) one or more divalent (M⁺⁺) metal salt(s); wherein the divalent (M⁺⁺) salt is selected from the consisting group of M⁺⁺ chloride or M⁺⁺ sulfate or M⁺⁺ carbonate, wherein the weight ratio of M to M⁺⁺ is from about 1:70 to about 70:1 (FIGS. 2a and 2b).

In another embodiment, the present application discloses a biodegradable water-soluble dispersant composition.

In one embodiment, the present application discloses weight ratio of M⁺ to M⁺⁺ to obtain functionalized carboxymethyl cellulose is from about 1:70 to about 70:1. In some embodiments, the weight ratio of M⁺ to M⁺⁺ is from about 1:3 to about 3:1; or from about 1:5 to about 5:1; or from about 1:10 to about 10:1; or from about 1:20 to about 20:1; or from about 1:30 to about 30:1; or from about 1:40 to about 40:1; or from about 1:50 to about 50:1; or from about 1:60 to about 60:1; or from about 1:70 to about 70:1. In another non-limiting embodiment, the preferred weight ratio of M⁺ to M⁺⁺ is from about 1:3 to about 3:1; or from about 1:5 to about 5:1; or from about 1:10 to about 10:1.

In one embodiment, the present application discloses, the molecular weight of the carboxymethyl cellulose is low to medium. In some embodiments, the low to medium weight average molecular weight is in the range of from about 2000 to about 400000 Daltons. In some embodiments, the low molecular weight ranges from about 2000 to about 5000 Daltons; or from about 5000 to about 10000 Daltons. In some embodiments, the medium molecular weight ranges from about 10000 to about 15000 Daltons; or from about 15000 to about 20000 Daltons; or from about 20000 to about 300000; or from about 30000 to about 40000 Daltons; or from about 40000 to about 50000 Daltons; or from about 50000 to about 60000 Daltons; or from about 60000 to about 70000 Daltons; or from about 70000 to about 80000 Daltons; or from about 80000 to about 90000 Daltons; or from about 90000 to about 100000 Daltons; or from about 100000 to about 200000 Daltons; or from about 200000 to about 300000 Daltons; or from about 300000 to about 400000 Daltons.

In some embodiments, the degree of substitution of the carboxymethyl cellulose is between about 0.4 and about 0.9. In more specific embodiments, the degree of substitution is from about 0.4 to about 0.5; or from about 0.5 to about 0.6; or from about 0.6 to about 0.7; or from about 0.7 to about 0.8; or from about 0.8 to about 0.9.

In another embodiment, the present application discloses a functionalized carboxymethyl cellulose is in the form of microcrystalline, granular, or powder or solution.

In another embodiment, the present application discloses a functionalized carboxymethyl cellulose contains 0.1 to 10% by weight of monovalent cation and 0.1 to 10% by weight of one or more divalent cations.

In another embodiment, the present application discloses a water-soluble dispersant composition is in the form of a liquid, solid, semisolid, emulsion, powder, dispersion, or gel.

In another embodiment, the present application discloses a water-soluble dispersant composition in liquid form having a viscosity of from about 15 to about 2000 cps.

In another embodiment, the present application discloses a water-soluble dispersant composition used for household, industrial and/or commercial operations.

In another embodiment, the present application discloses a water-soluble dispersant composition comprising functionalized carboxymethyl cellulose present in an amount of from about 0.1 wt. % to about 1 wt. %; or from about 1 wt. % to about 2.5 wt. %; or from about 2.5 wt. % to about 5 wt. %; or from about 5 wt. % to about 10 wt. %; or from about 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. % or from about 80 wt. % to about 85 wt. % or 85 wt. % to about 90 wt. %; or 90 wt. % to about 95 wt. %; or 95 wt. % to about 99.9 wt. % based on the total weight of the composition.

In another embodiment, the present application discloses a water soluble dispersant composition comprising an optional adjunct material present in an amount of 0.0; or from about 0.1 wt. % to about 1 wt. %; or from about 1 wt. % to about 2.5 wt. %; or from about 2.5 wt. % to about 5 wt. %; or from about 5 wt. % to about 10 wt. %; from about 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. % based on the total weight of the composition.

In one embodiment, the present application discloses a water-soluble laundry or detergent composition comprising: (i) about 0.1 wt. % to about 90.0 wt. % composition comprising a low to medium molecular weight carboxymethyl cellulose functionalized with at least one mono-valent cation and at least one di-valent cation(s); and (ii) optionally, about 0.0 wt. % to about 50 wt. %, of at least one or more adjunct materials; wherein the functionalized carboxymethyl cellulose is functioning as (a) dispersant; (b) a soil removal agent and (c) an anti-soil redeposition agent.

In another embodiment, the present application discloses a water-soluble laundry or detergent composition comprising functionalized carboxymethyl cellulose present in an amount of from about 0.1 wt. % to about 1 wt. %; or from about 1 wt. % to about 2.5 wt. %; or from about 2.5 wt. % to about 5 wt. %; or from about 5 wt. % to about 10 wt. %; or from about 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. %; or from about 50 wt. % to about 55 wt. %; or from about 55 wt. % to about 60 wt. %; or from about 60 wt. % to about 65 wt. %; or from about 65 wt. % to about 70 wt. %; or from about 70 wt. % to about 75 wt. %; or from about 75 wt. % to about 80 wt. % or from about 80 wt. % to about 85 wt. % or 85 wt. % to about 90 wt. % based on the total weight of the composition.

In another embodiment, the present application discloses a water-soluble laundry or detergent composition comprising optional adjunct material present in an amount of 0.0; or from about 0.1 wt. % to about 1 wt. %; or from about 1 wt. % to about 2.5 wt. %; or from about 2.5 wt. % to about 5 wt. %; or from about 5 wt. % to about 10 wt. %; from about 10 wt. % to about 15 wt. %; or from about 15 wt. % to about 20 wt. %; or from about 20 wt. % to about 25 wt. %; or from about 25 wt. % to about 30 wt. %; or from about 30 wt. % to about 35 wt. %; or from about 35 wt. % to about 40 wt. %; or from about 40 wt. % to about 45 wt. %; or from about 45 wt. % to about 50 wt. % based on the total weight of the composition.

In another embodiment, the present application discloses a laundry or detergent composition is a ready-to-use product, an additive rinse cycle composition, or a dilutable detergent.

In another embodiment, the present application discloses to form the laundry or detergent compositions, the dispersant or anti-soil redeposition agent is added to a dry detergent powder or liquid detergent or detergent solution in the desired concentration and the temperature and pH adjusted so that the polymer is in a solution phase at the start of the washing cycle. Generally, a pH of between about 6 and about 13 and a temperature between about 10° C. and about 80° C. is recommended for the beginning of the washing operation.

In another embodiment, the present application discloses a laundry or detergent composition wherein the functionalized carboxymethyl cellulose is biodegradable.

In one embodiment, the present application discloses a laundry or detergent composition comprising a method of providing soil removal from and anti-soil redeposition on a fabric comprising the steps of: (i) washing or contacting one or more fabrics or textile articles with wash solution containing a laundry or detergent composition at one or more points during the main wash of laundering process; (ii) rinsing said fabrics or textile articles with water; and (iii) allowing said fabrics or textile articles to air dry naturally or mechanically tumble-drying them, wherein said fabric is selected from the group consisting of natural fabric, synthetic fabric, natural non-woven fabric and/or synthetic non-woven fabric, cotton, denim, polyacrylics, polyamides, polyesters, polyolefins, rayons, wool, linen, jute, ramie, hemp, sisal, regenerated cellulosic fibers, leather, and combinations thereof.

The laundry or detergent composition can further include one or more laundry adjunct materials which are used in the conventional detergent compositions. Such adjunct materials are well known to those skilled in the art and can include, but are not limited to, builders, ion exchangers, alkalies, anticorrosion materials, antiredeposition materials, optical brighteners, fragrances, dyes, chelating agents, enzymes, whiteners, brighteners, antistatic agents, sudsing control agents, solvents, hydrotropes, bleaching agents, bleach stabilizers or activators thereof, perfumes, water, buffering agents, soil removal agents, soil release agents, softening agents, opacifiers, inert diluents, graying inhibitors, stabilizers, polyelectrolytes, anti-shrinking agents, anti-wrinkle agents, anti-spotting agents, sunscreens, anti-corrosion agents, drape imparting agents, deodorants, emollients, moisturizers, foam boosters, germicides, lathering agents, skin conditioners, solvents, stabilizers, and superfatting agents.

Examples of suitable synthetic anionic surfactants include sodium lauryl sulphate, sodium lauryl ether sulphate, ammonium lauryl sulphosuccinate, ammonium lauryl sulphate, ammonium lauryl ether sulphate, sodium cocoyl isethionate, sodium lauroyl isethionate, and sodium N-lauryl sarcosinate. Synthetic anionic surfactants comprise the synthetic anionic surfactant linear alkylbenzene sulphonate (LAS), sodium alcohol ethoxy-ether sulphate (SAES), sodium C12 alcohol ethoxy-ether sulphate (SLES). Anionic surfactants used in laundry include, but are not limited to, linear alkyl benzene sulfonates, ethoxylated C12-C15 fatty alcohols, alkyl sulfates, ether sulfates, secondary alkyl sulfates, α-olefin sulfonate, phosphate esters, sulfosuccinates, isethionates, carboxylates.

Suitable examples of nonionic surfactants useful for the detergent composition of the present disclosure can include alkoxylated materials, particularly addition products of ethylene oxide and/or propylene oxide with fatty alcohols, fatty acids and fatty amines.

The alkoxylated materials can have the general formula:

R—Y—(CH₂CH₂O)_{z}H

where R is a hydrophobic moiety, typically being an alkyl or alkenyl group, the group being linear or branched, primary or secondary, and having from about 8 to about 25 carbon atoms, or from about 10 to about 20 carbon atoms, or from about 10 to about 18 carbon atoms. R can also be an aromatic group, such as a phenolic group, substituted by an alkyl or alkenyl group as described above; Y is a linking group, typically being O, CO·O, or CO·N(R1), where R1 is H or a C₁-C₄ alkyl group; and z represents the average number of ethoxylate (EO) units present, the number being about 8 or more, or about 10 or more, from about 10 to about 30, or from about 12 to about 25, or from about 12 to about 20.

Examples of suitable nonionic surfactants can include the ethoxylates of mixed natural or synthetic alcohols in the “coco” or “tallow” chain length. In one non-limiting embodiment, the non-ionic surfactants can be condensation products of coconut fatty alcohol with about 15-20 moles of ethylene oxide and condensation products of tallow fatty alcohol with about 10-20 moles of ethylene oxide.

The ethoxylates of secondary alcohols such as 3-hexadecanol, 2-octadecanol, 4-eicosanol, and 5-eicosanol can also be used. Exemplary ethoxylated secondary alcohols can have formulae C₁₂-EO(20); C₁₄-EO(20); C₁₄-EO(25); and C₁₆-EO(30). The secondary alcohols can include Tergitol™ 15-S-3 (available from The Dow Chemical Company) and those disclosed in PCT/EP2004/003992, which is enclosed herein by reference in its entirety.

Polyol-based nonionic surfactants can also be used, examples including sucrose esters (such as sucrose monooleate), alkyl polyglucosides (such as stearyl monoglucoside and stearyl triglucoside), and alkyl polyglycerols.

The nonionic surfactants used in the present laundry or detergent composition can be reaction products of long-chain alcohols with several moles of ethylene oxide having a weight average molecular weight of about 300 to about 3000 Daltons. One of the nonionic surfactants of the blend is a lower hydrophillic ethoxylate. The lower hydrophillic ethoxylate is linear alcohol ethoxylate where a C9-C11 and/or C12-C18 linear alcohol chain is ethoxylated with an average of 1.0 to 5.0 moles of ethylene oxide per chain, or 2.0 to 4.0 moles of ethylene oxide.

The nonionic surfactant can also be a higher ethoxylate. The higher ethoxylate is a linear alcohol ethoxylate where a C9-C11 and/or C12-C18 linear alcohol chain is ethoxylated with at least 6.0 moles of ethylene oxide per chain, or an average of 6.0 to 20.0 moles of ethylene oxide per chain, or an average of 6.0 moles to 12.0 moles of ethylene oxide per chain. The ratio of lower ethoxylate to higher ethoxylate can be in the range of from about 1:10 to about 10:1, or from about 1:4 to 4:1.

In one non-limiting embodiment, the nonionic surfactants can be mixtures of C9-C11 linear alcohols ethoxylated with an average of 2.5, 6.0 and 8.0 moles of ethylene oxide per chain. The ratio of the 6 mole ethoxylates to 2.5 moles ethoxylates in the blend is preferably in the range of 1.5:1 to 2:1 and for 8 mole ethoxylates is in the range of 2.3:1.

Amphoteric surfactants suitable for use in the present laundry or cleaning composition can include those that are broadly described as derivatives of aliphatic secondary and tertiary amines in which the aliphatic radical can be straight or branched chain and wherein one of the aliphatic substituents contains from about 8 to about 18 carbon atoms and one contains an anionic water solubilizing group, e.g., carboxy, sulfonate, sulfate, phosphate, or phosphonate. Examples of compounds falling within this definition are sodium 3-dodecyl-aminopropionate, sodium 3-dodecylaminopropane sulfonate, sodium lauryl sarcosinate, N-alkyltaurines such as the one prepared by reacting dodecylamine with sodium isethionate according to the teaching of U.S. Pat. No. 2,658,072, N-higher alkyl aspartic acids such as those produced according to the teaching of U.S. Pat. No. 2,438,091, and the products described in U.S. Pat. No. 2,528,378.

Zwitterionic surfactants suitable for use can include those that are broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group, e.g., carboxy, sulfonate, sulfate, phosphate, or phosphonate. Zwitterionic surfactants which are suitable include betaines, including cocoamidopropyl betaine.

The amphoteric surfactants suitable herein may also include alkylamphoacetates including lauroamphoacetate and cocoamphoacetate. Alkylamphoacetates can be comprised of monoacetates and diacetates. In some types of alkylamphoacetates, diacetates are impurities or unintended reaction products.

Further, the surfactant can be present in an amount of from about 0.0 wt. % to about 80.0 wt. %, or from about 0.0 wt. % to about 50.0 wt. %, or from about 0.0 wt. % to about 20.0 wt. % of the total detergent composition.

The laundry or detergent composition according to the present disclosure may further comprise detergency adjuvants or builders to improve the surface properties of surfactants. Builders can be organic and/or inorganic. The inorganic builders can include, but are not limited to, alkali metal ammonium or alkanolamine polyphosphates; alkali metal pyrophosphates; zeolites; silicates; alkali metal or alkaline earth metal borates, carbonates, bicarbonates or sesquicarbonates; and cogranules of alkali metal (sodium or potassium) silicate hydrates and of alkali metal (sodium or potassium) carbonates.

The organic builders can include, but are not limited to, organic phosphates; and polycarboxylic acids and/or their water-soluble salts and water-soluble salts of carboxylic polymers. Suitable examples can include, but are not limited to, polycarboxylate or hydroxypolycarboxylate ethers; polyacetic acids or their salts (nitriloacetic acid, N,N-dicarboxymethyl-2-aminopentanedioic acid, ethylenediaminetetraacetic acid, diethylenetriaminepentaacetic acid, ethylenediaminetetraacetates, nitrilotriacetates); (C5-C20 alkyl)succinic acid salts; polycarboxylic acetal esters; polyaspartic or polyglutamic acid salts; and citric acid, gluconic acid or tartaric acid or their salts.

In another embodiment of the present application a complete list of ingredients routinely added to laundry or detergent compositions is found in McCutcheon's 2012 Emulsifiers & Detergents and McCutcheon's Functional Materials directories of detergent ingredients.

In another embodiment of the present application a complete adjuvant such as, starch derivatives, sodium sulphate, sodium acetate, urea, polyvinyl (poly)pyrrolidone compounds, glycerol, stearate compounds, polyethylene glycols of a molecular weight of between 100-6,000 as well as mixtures thereof.

In another embodiment of the present application water-soluble phosphorous-containing inorganic detergency builders, include the alkali-metal orthophosphates, metaphosphates, pyrophosphates and polyphosphates. Specific examples of inorganic phosphate builders include potassium or sodium citrate, sodium and potassium tripolyphosphates, orthophosphates and hexametaphosphates.

In another embodiment of the present application suitable polymeric rheology modifiers include those of the polyacrylate, polysaccharide or polysaccharide derivative type. Polysaccharide derivatives typically used as rheology modifiers comprise polymeric gum materials. Such gums include pectin, alginate, arabinogalactan (gum Arabic), carrageenan, gellan gum, xanthan gum and guar gum.

In another embodiment of the present application suitable radical scavenger is preferably selected from mono-, di- and trihydroxybenzenes, especially mono-tert-butyl-hydroxytoluene, di-tert-butyl-hydroxytoluene, p-hydroxytoluene, hydroquinone, mono-tert-butyl-hydroquinone, di-tert-butyl-hydroquinone.

In one embodiment, the present application discloses suitable chelating agents such as the ones selected from the group comprising phosphonate chelating agents, amino carboxylate chelating agents or other carboxylate chelating agents, or polyfunctionally-substituted aromatic chelating agents or mixtures thereof.

In one embodiment, the present application discloses foam regulators inhibit the formation of suds the washing cycle. Foam regulators prevent the formation of foam by disrupting the surfactants at the air-water interface of the forming bubble, or cause foam bubbles to collapse by forming hydrophobic bridges across multiple bubbles selected from soaps, siloxanes and paraffins.

In one embodiment, the present application discloses examples of the viscosity control agent include, but are not limited to, polypropylene glycol, materials containing propylene oxide groups, materials containing polyethylene oxide groups, polysorbate polyethylene glycol, glycerin, diethylene glycol, polypropylene oxide, and alkoxylates based on ethylene oxide and propylene oxide.

In one embodiment, the present application discloses preferred anti-static agents herein are water-soluble sulfonated polymers, quaternary ammonium salts, quaternary imidazolinium salts, alkyl pryidinium salts, alkyl morpholinium salts, and quaternary derivatives of silicones, and the like.

Optical brighteners or whitening agents mask the appearance of an undesirable color, such as the yellowing of fabric that occurs naturally over time by introducing a complementary color. Optical brighteners attach to fabrics, absorb invisible ultraviolet light and convert it to visible blue-violet light. The blue light that is emitted interacts with the yellow light emitted by the fabric, giving an overall appearance of whiteness. Optical brighteners include aminotriazines, coumarins and stilbenes. Brighteners are also disclosed in Kirk-Othmer Encyclopedia of Chemical Technology, John Wiley & Sons (1985) at pp. 184-185.

Hydrotropes or solubilizers, assist in maintaining the pouring characteristics of liquid detergents by preventing gel formation or separation into layers in the bottle. They maintain a uniform composition throughout the liquid detergent. Hydrotropes includes xylene sulfonate, sodium xylene sulfonate. cumene sulfonate, some glycol ether sulphates and urea.

Other laundry or detergent composition additives which can be included to the composition can be selected from the group comprising antimicrobials, antibacterial agents, dyes or colorants, fillers compounds, functional polymers, stabilizers, solvents, soil release polymers, preservatives, fragrances, antimicrobials, dust mile repellents, dust mite repellents, chlorine scavengers, UV absorbers, bleaching agents, oxidation catalysts, zeolites, finishing agents and/or odor suppressing agents.

The compositions according to the application may be analyzed by known techniques.

Especially preferred are the techniques of 13C nuclear magnetic resonance (NMR) spectroscopy, gas chromatography (GC), Infra-red (IR), Liquid Chromatography (LC) and gel permeation chromatography (GPC) in order to decipher identity, residual monomer concentrations, molecular weight, and molecular weight distribution.

Further, certain aspects of the present application are illustrated in detail by way of the following examples. The examples are given herein for illustration of the application and are not intended to be limiting thereof.

### EXAMPLES

Manufacturing and application of functionalized carboxymethyl cellulose directed to laundry or detergent compositions containing a low molecular weight carboxymethyl cellulose functionalized with at least one mono-valent cation and at least one di-valent cation, as well as to the process and method of producing laundry or detergent compositions.

### Example 1: Synthesis of Low Molecular Weight Sodium/Calcium [CMC XA1517-118-1]

5.95 grams of anhydrous calcium chloride were dissolved in 320 grams deionized water with stirring for 30 minutes. Next, 1,280 grams of methanol were added with continual stirring. 128 grams of Aqualon™ CMC 7L2 grade carboxymethylcellulose supplied by Ashland Specialty Ingredients were added to this solution with continual stirring, creating a heterogenous slurry. This mixture was stirred for 20 hours before being filtered to obtain a wet-cake. The wet-cake was dispersed in 1,600 grams of 80/20 w/w methanol/water and stirred for 30 minutes before filtering again. This step was repeated two additional times and then a final wash in 1,600 grams of neat methanol was carried out. The final material was dried at 65° C. using a fluid bed dryer until total moisture content of the final product was under 5 weight percent.

### Example 2: Synthesis of Low Molecular Weight Sodium/Calcium [CMC XA1517-118-2]

17.80 grams of anhydrous calcium chloride were dissolved in 320 grams deionized water with stirring for 30 minutes. Next, 1,280 grams of methanol were added with continual stirring. 128 grams of Aqualon™ CMC 7L2 grade carboxymethylcellulose supplied by Ashland Specialty Ingredients were added to this solution with continual stirring, creating a heterogenous slurry. This mixture was stirred for 20 hours before being filtered to obtain a wet-cake. The wet-cake was dispersed in 1,600 grams of 80/20 w/w methanol/water and stirred for 30 minutes before filtering again. This step was repeated two additional times and then a final wash in 1,600 grams of neat methanol was carried out. The final material was dried at 65° C. using a fluid bed dryer until total moisture content of the final product was under 5 weight percent.

### Example 3: Synthesis of Low Molecular Weight Sodium/Magnesium [CMC XA1517-119-1]

5.10 grams of anhydrous magnesium chloride were dissolved in 320 grams deionized water with stirring for 30 minutes. Next, 1,280 grams of methanol were added with continual stirring. 128 grams of Aqualon™ CMC 7L2 grade carboxymethylcellulose supplied by Ashland Specialty Ingredients were added to this solution with continual stirring, creating a heterogenous slurry. This mixture was stirred for 20 hours before being filtered to obtain a wet-cake. The wet-cake was dispersed in 1,600 grams of 80/20 w/w methanol/water and stirred for 30 minutes before filtering again. This step was repeated two additional times and then a final wash in 1,600 grams of neat methanol was carried out. The final material was dried at 65° C. using a fluid bed dryer until total moisture content of the final product was under 5 weight percent.

### Example 4: Synthesis of Low Molecular Weight Sodium/Magnesium [CMC XA1517-119-2]

11.50 grams of anhydrous magnesium chloride were dissolved in 320 grams deionized water with stirring for 30 minutes. Next, 1,280 grams of methanol were added with continual stirring. 128 grams of Aqualon™ CMC 7L2 grade carboxymethylcellulose supplied by Ashland Specialty Ingredients were added to this solution with continual stirring, creating a heterogenous slurry. This mixture was stirred for 20 hours before being filtered to obtain a wet-cake. The wet-cake was dispersed in 1,600 grams of 80/20 w/w methanol/water and stirred for 30 minutes before filtering again. This step was repeated two additional times and then a final wash in 1,600 grams of neat methanol was carried out. The final material was dried at 65° C. using a fluid bed dryer until total moisture content of the final product was under 5 weight percent.

### Example 5: Synthesis of Low Molecular Weight Sodium/Zinc [CMC XA1517-120-1]

7.30 grams of anhydrous zinc chloride were dissolved in 320 grams deionized water with stirring for 30 minutes. Next, 1,280 grams of methanol were added with continual stirring. 128 grams of Aqualon™ CMC 7L2 grade carboxymethylcellulose supplied by Ashland Specialty Ingredients were added to this solution with continual stirring, creating a heterogenous slurry. This mixture was stirred for 20 hours before being filtered to obtain a wet-cake. The wet-cake was dispersed in 1,600 grams of 80/20 w/w methanol/water and stirred for 30 minutes before filtering again. This step was repeated two additional times and then a final wash in 1,600 grams of neat methanol was carried out. The final material was dried at 65° C. using a fluid bed dryer until total moisture content of the final product was under 5 weight percent.

### Example 6: Synthesis of Low Molecular Weight Sodium/Zinc [CMC XA1517-120-2]

16.40 grams of anhydrous zinc chloride were dissolved in 320 grams deionized water with stirring for 30 minutes. Next, 1,280 grams of methanol were added with continual stirring. 128 grams of Aqualon™ CMC 7L2 grade carboxymethylcellulose supplied by Ashland Specialty Ingredients were added to this solution with continual stirring, creating a heterogenous slurry. This mixture was stirred for 20 hours before being filtered to obtain a wet-cake. The wet-cake was dispersed in 1,600 grams of 80/20 w/w methanol/water and stirred for 30 minutes before filtering again. This step was repeated two additional times and then a final wash in 1,600 grams of neat methanol was carried out. The final material was dried at 65° C. using a fluid bed dryer until total moisture content of the final product was under 5 weight percent.

### Synthesis of Na/M⁺⁺ CMC

TABLE 1
Characteristics of prototype Na/M⁺⁺ CMC

| | | | | | | Mol. Wt | |
|---|---|---|---|---|---|---|---|
| | | % Na | % Ca | % Mg | % Zn | (Mw) | Degree of |
| Ingredients | Description | (w/w) | (w/w) | (w/w) | (w/w) | (Daltons) | substitution |
| Benchmark | Na—CMC | 6.59 | — | — | — | 82100 | 0.69 |
| XA1517-118-1 | Na/Ca—CMC | 5.60 | 1.47 | — | — | 84400 | 0.65 |
| XA1517-118-2 | Na/Ca—CMC | 3.23 | 3.46 | — | — | 84500 | 0.65 |
| XA1517-119-1 | Na/Mg—CMC | 5.73 | — | 0.82 | — | 84800 | 0.71 |
| XA1517-119-2 | Na/Mg—CMC | 4.74 | — | 1.34 | — | 84000 | 0.64 |
| XA1517-120-1 | Na/Zn—CMC | 5.49 | — | — | 2.59 | 85300 | 0.63 |
| XA1517-120-2 | Na/Zn—CMC | 3.78 | — | — | 5.25 | 85600 | 0.6 |

### Example 7: Preparation of Prototype Laundry or Detergent Composition

25% active surfactants in detergent formulation containing a 2:1 ratio of anionic:nonionic surfactants commonly used in detergent chassis was prepared by mixing the ingredients listed in Table 1. Once all the components in the Table 2 were thoroughly mixed to yield a clear solution, the pH of the prototype detergent was adjusted to 8.85 by dropwise addition of Aminomethyl propanol (AMP Ultra PC 2000, Angus Chemical Company). This detergent was used in following laundry applications.

TABLE 2
Prototype Laundry or Detergent Composition

| | Amount | |
|---|---|---|
| Ingredients | (g) | % Active |
| Deionized water | 54.71 | 54.71 |
| Linear alkylbenzene sulfonate | 16.53 | 10.00 |
| Sodium lauryl ethyl sulfate | 10.11 | 7.00 |
| Sodium xylene sulfonate | 4.65 | 2.00 |
| Sodium citrate | 2.00 | 2.00 |
| Propylene glycol | 4.00 | 4.99 |
| Alcohol ethoxylate C12-15/7EO | 8.00 | 8.00 |
| Total | 100.00 | 87.71 |

### Example 8: Laundry Method and Anti-Soil Redeposition Performance Measurement

2% (w/w) solutions of benchmark Sodium CMC and individual divalent cation modified Na/M⁺⁺ carboxymethyl celluloses used as anti-soil redeposition agents (ASR) were prepared by dissolving 1 gram of individual Na/M⁺⁺ carboxymethyl cellulose in D.I water to make 50-gram solution.

Lab scale laundry was performed on a Tergotometer instrument (Testfabric Inc., USA) fitted with six individual bins. 2 pieces of clean washed cotton 400 fabrics (3-inch×4-inch, Scientific Services S/D. Inc) were used per bin as the acceptor fabric. The same pair of cotton acceptor fabrics per bin was used all throughout the 6 wash-rinse cycles. 6 pieces of Cotton 400 fabrics ground in clay (3-inch×4-inch, Scientific Services S/D. Inc), were used per bin for each wash cycle as soil donors. Unlike the acceptor fabrics, fresh new 6 pieces of donor cotton fabric ground in clay were added to each bin at the end of each wash cycle and discarded at the end of each subsequent rinse cycle. 6 consecutive wash-rinse cycles were carried out whereby the first three wash cycles were carried out with detergent added to the wash liquid, while the last three wash cycles were carried out without any detergent in the wash liquid. Solutions of benchmark ASR agent or the prototype Na/M⁺⁺ CMCs used as anti-soil redeposition agents (ASRs) and hard water were present in wash liquids for all 6 wash cycles.

First three consecutive wash-rinse cycles were carried out with detergent in the wash liquid. 500 g of wash liquid for each bin of the Tergotometer was prepared by diluting 2 g of prototype detergent of Example 2, 25 g of standard 3000 ppm WHO hard water (3:1 Calcium:Magnesium) and required amount of pre-made 2% aqueous solutions of either the benchmark Sodium CMC (Benchmark) or the Na/M⁺⁺ CMCs of Table 1 with deionized water to obtain required dosage (40 ppm, 20 ppm etc.) of anti-soil redeposition (ASR) agent in the wash liquid with a final hardness of 150 ppm. For control wash solution, only prototype detergent and standard WHO hard water was diluted to 500 g with deionized water. Each wash cycle was followed by a subsequent rinse cycle whereby rinse solution were prepared by diluting 25 g of standard 3000 ppm WHO hard water (3:1 Calcium:Magnesium) with D. I. water to yield 500 g rinse solutions for each bin of the Tergotometer with a final hardness of 150 ppm.

For the laundry cycle, each bin of the Tergotomere was charged with 2 acceptor fabrics and 6 fresh donor fabrics as mentioned above. The laundry liquid prepared as described above was charged into each designated bin of the Tergotometer. Laundry cycle was carried out for 15 minutes at 38° C. with 100 RPM agitation. After laundry cycle, the washed fabrics were removed, excess wash liquid was squeezed out of the fabrics, remaining wash liquid in the designated bin for the fabrics were discarded. The fabrics were put back in their designated bins for rinse cycle. The rinse solution prepared by as described above was charged into each bin. Rinse cycle was carried out at 38° C. for 5 minutes at 100 RPM agitation.

After completion of the first 3 consecutive wash rinse cycles, the acceptor fabrics and the donor fabrics from the last wash-rinse cycle were retrieved, air dried overnight and measured for graying due to soil deposition for the acceptor fabrics and cleaning due to soil removal for the donor fabrics.

On completion of color measurement, the same acceptor fabrics were subjected to three more consecutive wash-rinse cycles without any detergent present in the wash liquids. Last 3 consecutive wash-rinse cycle were carried out without any detergent in the wash liquids. 500 g of wash liquid for each bin of the Tergotometer was prepared by diluting 25 g of standard 3000 ppm WHO hard water (3:1 Calcium:Magnesium) and required amount of pre-made 2% aqueous solutions of either the benchmark Sodium CMC (Benchmark) or the Na/M⁺⁺ CMCs of Table 1 with deionized water to obtain required dosage (40 ppm, 20 ppm etc.) of anti-soil redeposition (ASR) agent in the wash liquid with a final hardness of 150 ppm. For control wash solution, only standard WHO hard water was diluted to 500 g with deionized water. Each wash cycle was followed by a subsequent rinse cycle whereby rinse solution were prepared by diluting 25 g of standard 3000 ppm WHO hard water (3:1 Calcium:Magnesium) with D. I. water to yield 500 g rinse solutions for each bin of the Tergotometer with a final hardness of 150 ppm.

For each of the last 3 the laundry cycle, each bin of the Tergotomere was charged with same 2 acceptor fabrics obtained at the end of the first 3 wash-rinse cycles and 6 fresh donor fabrics as mentioned above. The laundry liquid prepared as described above was charged into each designated bin of the Tergotometer. Laundry cycle was carried out for 15 minutes at 38° C. with 100 RPM agitation. After laundry cycle, the washed fabrics were removed, excess wash liquid was squeezed out of the fabrics, remaining wash liquid in the designated bin for the fabrics were discarded. The fabrics were put back in their designated bins for rinse cycle. The rinse solution prepared by as described above was charged into each bin. Rinse cycle was carried out at 38° C. for 5 minutes at 100 RPM agitation.

After completion of the last 3 consecutive wash rinse cycles, the acceptor fabrics and the donor fabrics from the last wash-rinse cycle were retrieved, air dried overnight and measured for graying due to soil deposition for the acceptor fabrics and cleaning due to soil removal for the donor fabrics.

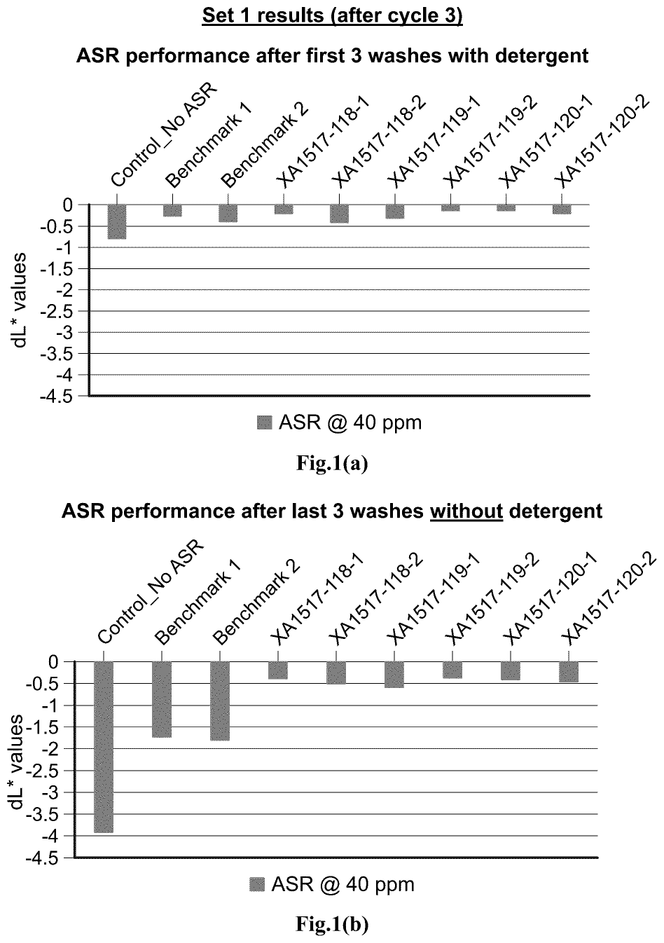

Reflectance color measurements of the washed acceptor and donor fabrics after first 3 and after last 3 consecutive wash-rinse cycles were performed on a HunterLab ColorQuest XE instrument interfaced with a computer in CIE L*C*h color space at 0°/8° illuminant/observer D65/10° setting with specular reflectance included. An average of twelve L*a*b* measurements (6 for each fabric) were collected and compared to average of twelve L*a*b* measurements (six for each fabric) for two pieces of clean cotton 400 acceptors not subjected to the above laundry process, to determine dL* as a measure of graying and soil deposition on white acceptor fabrics and reported in Table 3 and FIG. 1(a)—after first 3 washes with detergent and b—after last 3 washes without detergent) against the prototype anti-soil redeposition agent (ASR) used and the dosage of its use. A more negative value of dL* would suggest greater degree of graying of the acceptor white cotton 400 fabric due to soil deposition during laundry process. A less negative value of dL* therefore would suggest higher efficacy of the prototype material used as anti-soil redeposition (ASR) agent (Table 3) and FIG. 1(b).

TABLE 3
Anti-soil redeposition (ASR) performance results

| | | | Acceptor | |
|---|---|---|---|---|
| | | | fabric | Acceptor |
| | | | grayness | fabric |
| | | | after first | grayness |
| | | ASR | 3 washes | after last |
| | | dose in | with | 3 washes |
| | | wash | laundry | without |
| | | liquid | detergent | detergent |
| ASR samples | Description | (ppm) | dL* | dL* |
| Control - no | — | 0 | −0.8 | −3.92 |
| ASR | | | | |
| Benchmark 1 | Na/CMC | 40 | −0.34 | −1.57 |
| Benchmark 2 | Na/ | 40 | −0.40 | −1.80 |
| | Carboxymethyl | | | |
| | inulin | | | |
| XA1517-118-1 | Na/Ca—CMC | 40 | −0.21 | −0.39 |
| XA1517-118-2 | Na/Ca—CMC | 40 | −0.42 | −0.51 |
| XA1517-119-1 | Na/Mg—CMC | 40 | −0.32 | −0.59 |
| XA1517-119-2 | Na—Mg—CMC | 40 | −0.14 | −0.37 |
| XA1517-120-1 | Na/Zn—CMC | 40 | −0.14 | −0.41 |
| XA1517-120-2 | Na/Zn—CMC | 40 | −0.21 | −0.46 |

Note:
more negative dL* values indicate poorer anti-soil redeposition performance

What is claimed is:

1. A water-soluble, biodegradable dispersant composition comprising a low to medium molecular weight carboxylated polysaccharide functionalized with at least one mono-valent (M⁺) cation and at least one di-valent (M⁺⁺) cation.

2. The composition according to claim 1, wherein the functionalized carboxylated polysaccharide is selected from the group consisting of carboxymethyl cellulose, carboxymethyl inulin carboxymethyl guar, and carboxymethyl starch.

3. The composition according to claim 1, wherein the functionalized carboxylated polysaccharide is a carboxymethyl cellulose.

4. A water-soluble, biodegradable dispersant composition comprising a low to medium molecular weight carboxymethyl cellulose (CMC) functionalized with at least one mono-valent (M⁺) cation and at least one di-valent (M⁺⁺) cation.

5. The composition according to claim 4, wherein the functionalized carboxymethyl cellulose is a soil removing agent and an anti-soil redeposition agent.

6. The composition according to claim 4, wherein the functionalized carboxymethyl cellulose has a weight average molecular weight in the range of from about 2000 to about 400000 Daltons.

7. The composition according to claim 4, wherein the mono-valent cation is selected from the group consisting of sodium, potassium, and lithium.

8. The composition according to claim 4, wherein the di-valent cation is selected from the group consisting of calcium, magnesium, zinc, tin, copper, and combinations thereof.

9. The composition according to claim 4, wherein the functionalized carboxymethyl cellulose has a structure of: 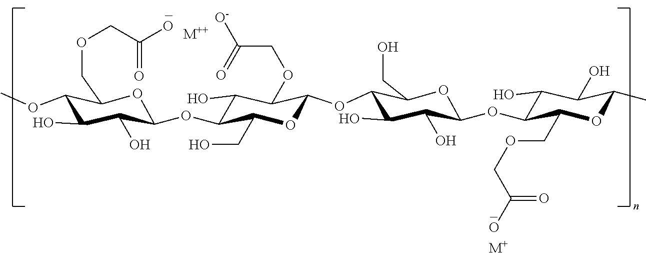
wherein,
M⁺ is a mono-valent cation selected from the group consisting of sodium, potassium, and lithium; and
M⁺⁺ is a di-valent cation selected from the group consisting of calcium, magnesium, zinc, tin, copper, and combinations thereof, and wherein n=2 to 500, M⁺=0.1 to 10 wt. % and M⁺⁺=0.1 to 10 wt. % of the carboxymethyl cellulose.

10. The composition according to claim 4, wherein the functionalized carboxymethyl cellulose is sodium-calcium carboxymethyl cellulose, sodium-magnesium carboxymethyl cellulose, sodium-zinc carboxymethyl cellulose. sodium-calcium-zinc-carboxymethyl cellulose, sodium-calcium-magnesium-carboxymethyl cellulose or sodium-magnesium-zinc-carboxymethyl cellulose.

11. The composition according to claim 4, wherein the composition further optionally comprises an adjunct material selected from the group consisting of surfactants, emulsifiers, detergents adjuvants, builders, stabilizers, rheology modifiers, solvents, radical scavengers, chelates, antifoaming agents, antistatic agent, antimicrobials, preservatives, dyes or colorants, dust mite repellents, viscosity control agents, opacifying agents, chlorine scavenger, brighteners, perfumes, finishing agents, UV absorbing or blocking agent, antibacterial agents, and solubilizing agents.

12. The composition according to claim 4, wherein the functionalized carboxymethyl cellulose has a degree of substitution is from about 0.4 to about 0.9.

13. The composition according to claim 4, wherein the functionalized carboxymethyl cellulose is in the form of microcrystalline, granular, or powder or solution.

14. The composition according to claim 4, wherein the functionalized carboxymethyl cellulose contains 0.1 to 10% by weight of monovalent cation and 0.1 to 10% by weight of one or more divalent cations.

15. The composition according to claim 4, wherein the composition is in the form of a liquid, solid, semisolid, emulsion, powder, dispersion, or gel.

16. The composition according to claim 15, wherein the liquid composition has a viscosity of from about 15 to about 2000 cps.

17. The composition according to claim 4, wherein the composition is used for household, industrial and/or commercial operations.

18. The composition according to claim 4, wherein the functionalized carboxymethyl cellulose is present in an amount of from about 0.1 wt. % to about 99.9 wt. % of the composition.

19. The composition according to claim 11, wherein the optional adjunct materials are present in an amount of from about 0.0 to about 80.0 wt. % of the composition.

20. The composition according to claim 4, wherein the functionalized carboxymethyl cellulose is obtained by ion-exchange process comprising a reaction of (i) at least one monovalent (M⁺⁺) carboxymethyl cellulose salt(s); and (ii) one or more divalent (M⁺⁺) metal salt(s);
wherein the divalent (M⁺⁺) salt is selected from the group consisting of M⁺⁺ chloride or M⁺⁺ sulfate or M⁺⁺ carbonate and
wherein the weight ratio of M⁺ to M⁺⁺ is from about 1:70 to about 70:1.

21. A water-soluble laundry or detergent composition comprising:
(i) about 0.1 wt. % to about 90.0 wt. % of the composition of claim 1 comprising a low to medium molecular weight carboxymethyl cellulose functionalized with at least one mono-valent cation and at least one di-valent cation(s); and
(ii) optionally, about 0.0 wt. % to about 50 wt. %, of at least one or more adjunct materials;
wherein the functionalized carboxymethyl cellulose is functioning as (a) dispersant; (b) a soil removal agent and (c) an anti-soil redeposition agent.

22. The laundry or detergent composition according to claim 21, wherein the functionalized carboxymethyl cellulose is sodium-calcium carboxymethyl cellulose, sodium-magnesium carboxymethyl cellulose, sodium-zinc carboxymethyl cellulose. sodium-calcium-zinc carboxymethyl cellulose, sodium-calcium-magnesium-carboxymethyl cellulose or sodium-magnesium-zinc-carboxymethyl cellulose.

23. The laundry or detergent composition according to claim 21, wherein the adjunct material is selected from the group consisting of surfactants, emulsifiers, detergents adjuvants, builders, stabilizers, rheology modifiers, solvents, radical scavengers, chelates, antifoaming agents, antistatic agent, antimicrobials, preservatives, dyes or colorants, dust mite repellents, viscosity control agents, opacifying agents, chlorine scavenger, brighteners, perfumes, finishing agents, UV absorbing or blocking agent, antibacterial agents, and solubilizing agents.

24. The laundry or detergent composition according to claim 21, wherein the pH of the composition is from about 6 to about 13 during the wash cycle.

25. The laundry or detergent composition according to claim 21, wherein the functionalized carboxymethyl cellulose is biodegradable.

26. The laundry or detergent composition according to claim 21, wherein the composition is a ready-to-use product, an additive rinse cycle composition, or a dilutable detergent.

27. A method for providing soil removal and an anti-soil redeposition of fabrics or textile articles comprising the steps of:
(i) washing or contacting one or more fabrics or textile articles with wash solution containing a laundry or detergent composition of claim 21 at one or more points during the main wash of laundering process:
(ii) rinsing said fabrics or textile articles with water; and
(iii) allowing said fabrics or textile articles to air dry naturally or mechanically tumble-drying them,
wherein said fabric or textile article are selected from the group consisting of natural fabric, synthetic fabric, natural non-woven fabric and/or synthetic non-woven fabric, cotton, denim, polyacrylics, polyamides, polyesters, polyolefins, rayons, wool, linen, jute, ramie, hemp, sisal, regenerated cellulosic fibers, leather, and combinations thereof.
